(19) United States
(12) Patent Application Publication
(10) Pub. No.: US 2014/0318498 A1
(43) Pub. Date: Oct. 30, 2014

(54) SYSTEM AND METHOD FOR INJECTOR COKING DIAGNOSTICS AND MITIGATION

(71) Applicant: FORD GLOBAL TECHNOLOGIES, LLC, Dearborn, MI (US)

(72) Inventors: Todd Anthony Rumpsa, Saline, MI (US); Joseph Norman Ulrey, Dearborn, MI (US); Eric Krengel, Dearborn, MI (US)

(73) Assignee: Ford Global Technologies, LLC, Dearborn, MI (US)

(21) Appl. No.: 13/869,582

(22) Filed: Apr. 24, 2013

(51) Int. Cl. F02D 41/30

(52) U.S. Cl. CPC F02D 41/3005
USPC 123/478

(57) ABSTRACT

A system and method for compensating for, or alleviating accumulation of, coking residues on fuel injectors is disclosed. The method includes adjusting an engine operating parameter based on a shift in a fuel injector current profile during an initial current rise of injector activation.

### TECHNICAL FIELD

The present application relates to fuel injectors, such as direct injection (DI) fuel injectors.

### BACKGROUND AND SUMMARY

Fuel injectors meter fuel to the engine through electromechanical actuation of a fuel injection valve. The opening duration of the valve, sometimes referred to as the injector pulsewidth may be adjusted to vary the amount of fuel delivered for an injection. To provide a requested amount of injected fuel, the opening duration may be determined based on operating conditions including the expected fuel flow amount while the injector is open. Unexpected changes to the injector operation can cause errors in the fuel metering. For example, coking of the injector, including build-up of deposits at a metering orifice of the valve, can affect the amount of fuel delivered for a given injection, but also changes in spray pattern. The changes to fuel metering may be significant, resulting in inaccurate air/fuel control and potential emissions or drivability implications.

One approach that attempts to address fuel injector variation of time, such as due to coking, is adaptive fuel correction based on measured air-fuel ratio. Therein, a feed-forward compensation is provided to the fuel metering based on measured air/fuel ratio shifts compared with expected air-fuel ratio assuming proper fuel metering.

However, the inventors herein have recognized various issues with such an approach. As one example, air metering errors may confound the fuel metering errors, resulting in improper correction of the fuel metering. As a second example, even if the fuel metering errors can be separately identified, it may not be possible to determine how to correct the fuel metering. In the example where the injector performance is mapped using a slope and offset (between pulsewidth and injection amount), measured air/fuel ratio shifts may be incorrectly used to update the slope, when in fact the offset needs updating, and vice versa.

Various approaches to at least partially address the above issues are provided. In one example, a method comprises adjusting an engine operating parameter based on a shift in a fuel injector current profile during an initial current rise of injector activation. For example, the fuel injector current profile during the initial current rise of the injector activation may provide an indication of injector coking that can be identified separately from other forms of fuel or air metering errors. In this way, a more accurate identification of fuel injector coking may be used to better adjust injector operation to compensate for, and/or address, the coking.

In one example, the initial rise, or boost phase, of the injector current profile may be used to characterize the injector opening behavior, and identify changes to that behavior over time due to coking. For example, the current profile, as the injector opens, can be affected by the force required to open the injector, which can be affected, over time, by coking. In this way, it is possible to identify fuel coking, separately from other fuel metering and/or air metering errors. Such improved identification enables more accurate compensation for coking, and/or measures to reduce the coking. This indications of may be monitored adaptively over repeated injector events to enable filtering and/or averaging for improved detection robustness.

In one example the opening time of the injector may increase as the degree of coking increases

An advantage of the example approaches is that it is possible to selectively adjust the fuel injector slope and offset separately from one another when coking is identified, as compared with other fuel metering degradation. Additionally, it is possible to selectively update the fuel metering separately from air metering, as fuel coking effects are independent of air metering errors.

The present disclosure describes a system and method for compensating for, or alleviating accumulation of coking residues on fuel injectors. The method comprises adjusting an engine operating parameter based on a shift in a fuel injector current profile during an initial current rise of injector activation. Identifying and compensating for injector coking in accordance with the present disclosure allows for adjustments to the timing and magnitude of voltage applied to the injector in contrast to mass adjustments made using previously known methods.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure. Further, the inventors herein have recognized the disadvantages noted herein, and do not admit them as known.

### BRIEF DESCRIPTION OF THE DRAWINGS

FIG. 1 is an example cylinder of a direct injection engine.

FIG. 2A is a schematic depiction of an input driver for a boost phase of fuel injection.

FIG. 2B is a schematic depiction of an input driver for a pickup phase of fuel injection.

FIG. 2C is a schematic depiction of an input driver for a hold phase of fuel injection.

FIG. 3 shows averaged current traces of the pickup and hold phase from a cleaned and coked injector.

FIG. 4 is a flow chart of a method for detecting alterations to fuel injection.

FIG. 5 is a method of correcting detected alterations to fuel injection.

### DETAILED DESCRIPTION

The present application describes various approaches for identifying fuel coking of an injector based on injector current profile during operation. In one example, the rate of initial current rise of the injector current is mapped to an indication of coking, and various adjustments are provided based on the identified coking. The rate of initial current rise may be an initial opening current profile as compared with an expected profile during injector opening to deliver fuel for combustion in the engine. The indication of coking may be used to adjust fuel injector parameters, such as a slope and/or offset between fuel injector pulsewidth and a fuel injection amount. Further fuel injector degradation may be indicated based on a degree of the injector coking, and/or remedial measures may be taken to reduce the coking.

In one example, a reduction in the current rate of rise may be an indication of increased coking, and a degree of the change in the injector rate of rise may be an indication of a degree of the coking. Further, the coking identification may be performed only under selected conditions, such as during low fuel pulsewidth conditions (e.g., less than a threshold) to better identify offset changes). The coking identification may be performed during high fuel pulsewidth conditions (e.g., greater than the threshold) to better identify slope changes. Further, combinations of both low and high pulsewidth coking identification may be used.

In another example, a shift (e.g., time delay) in the current profile may also be used as an indication of coking, with a greater shift indicating a greater degree of coking. In this way, fuel metering changes due to coked injectors, from both the changes to the opening time (which results in an offset to fuel metering) and changes to a static flow capability (which results in a slope change to fuel metering), can be identified, indicated, and addressed.

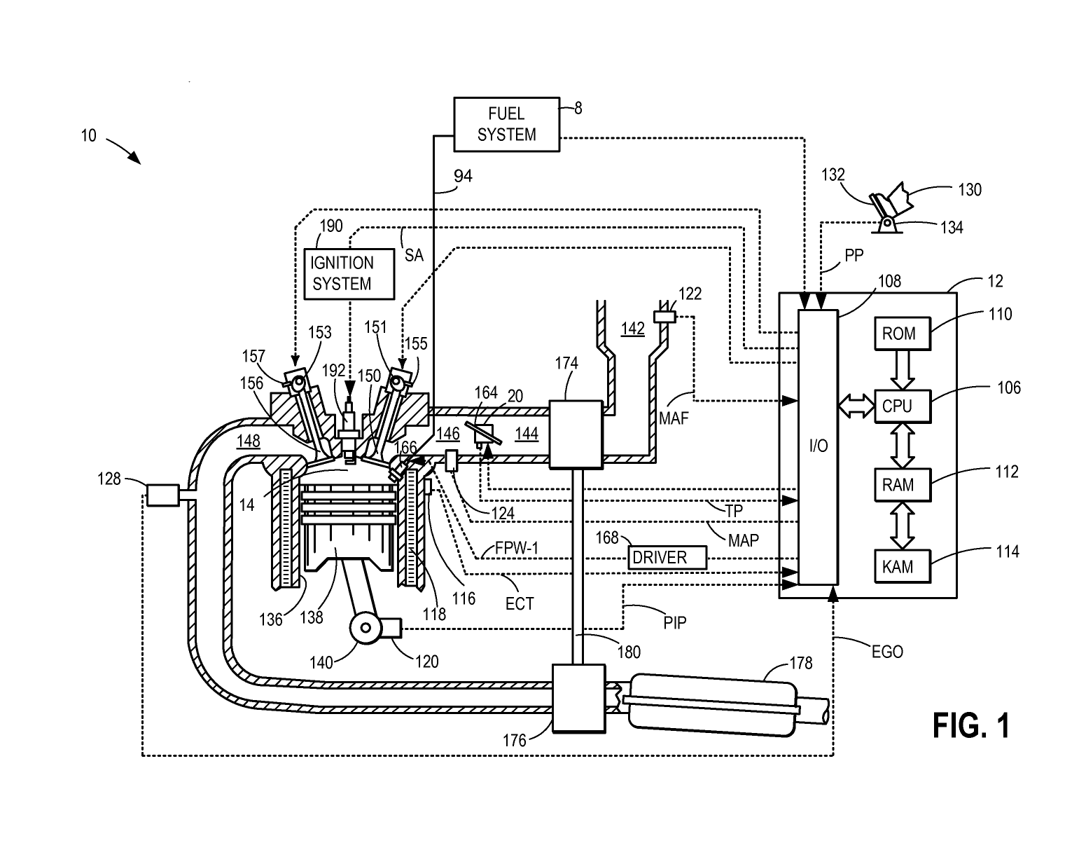

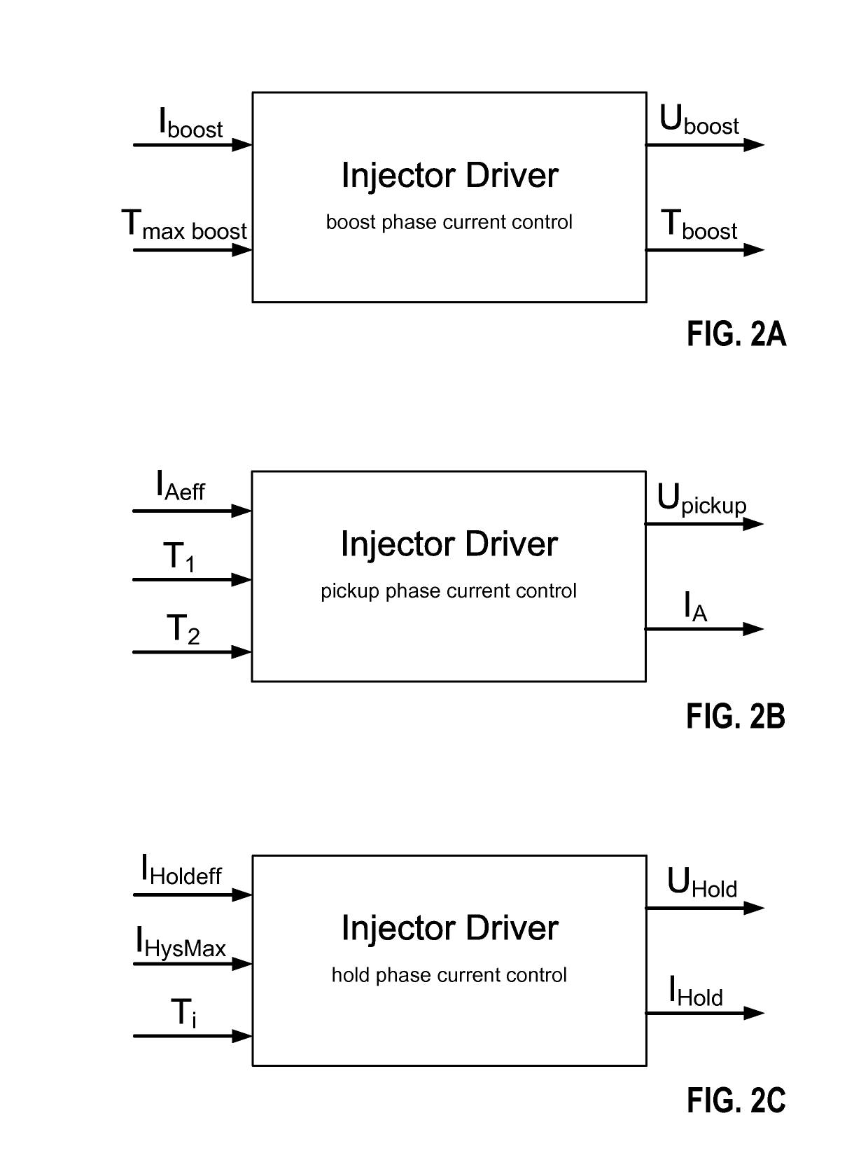

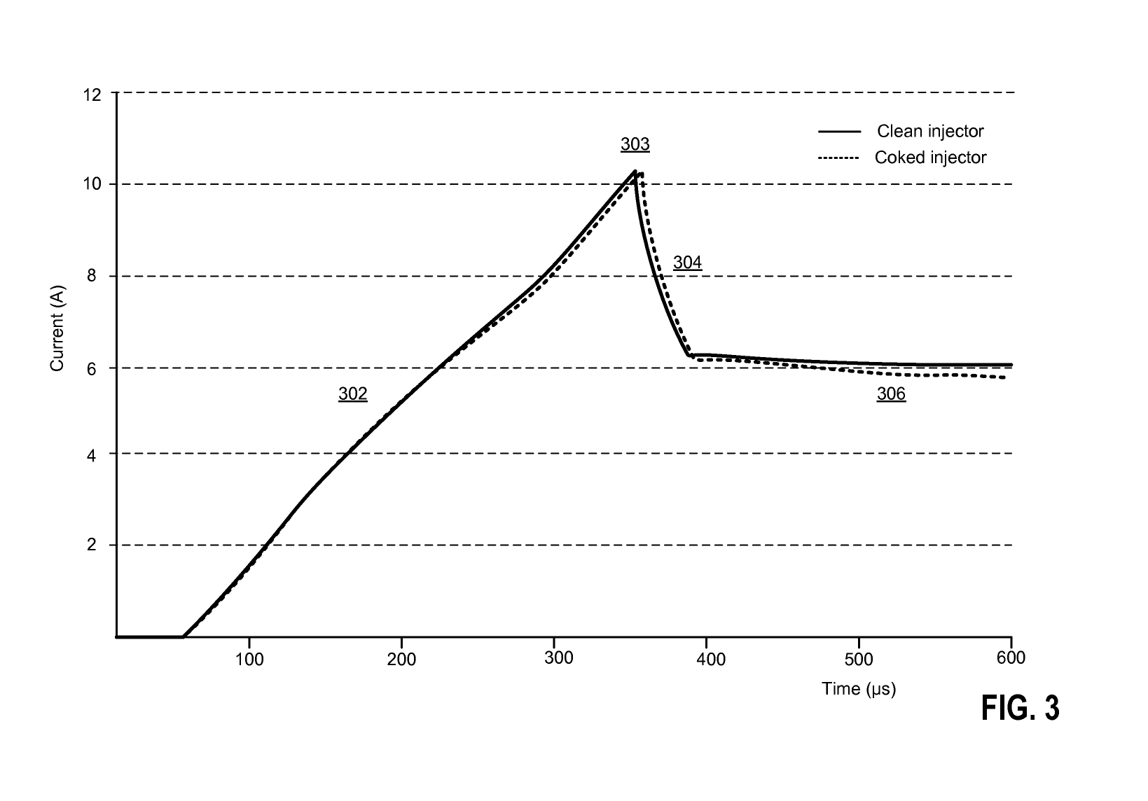

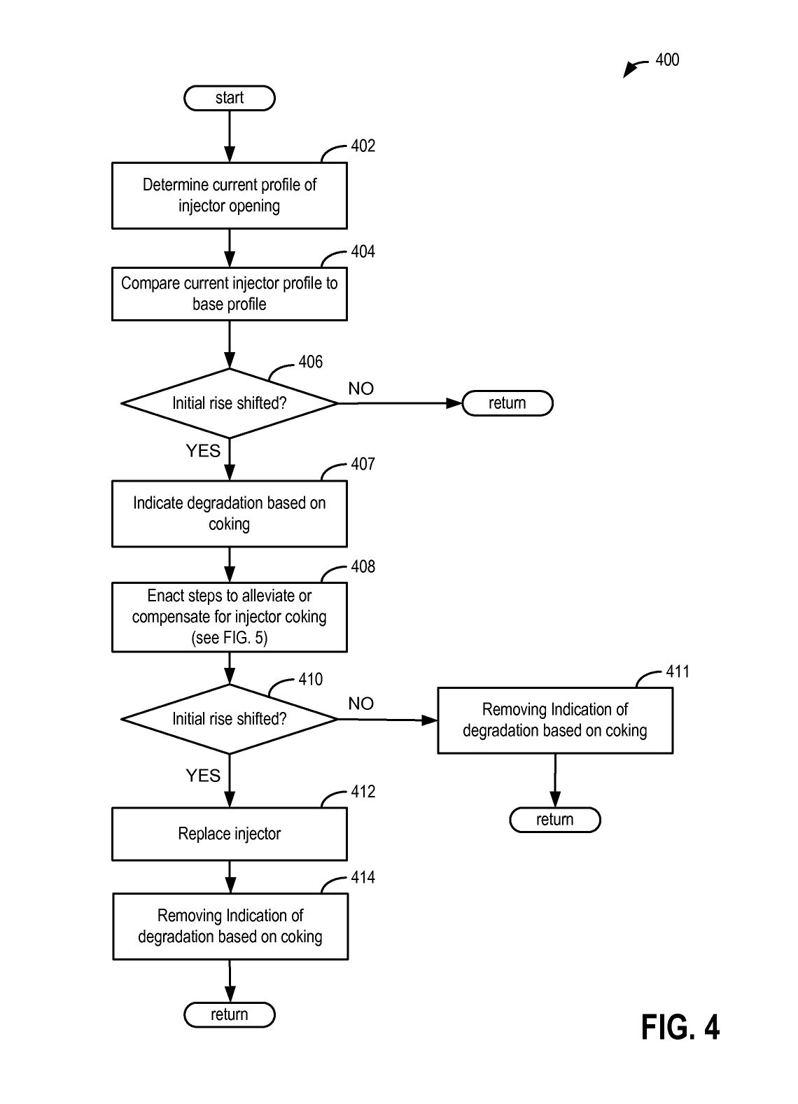

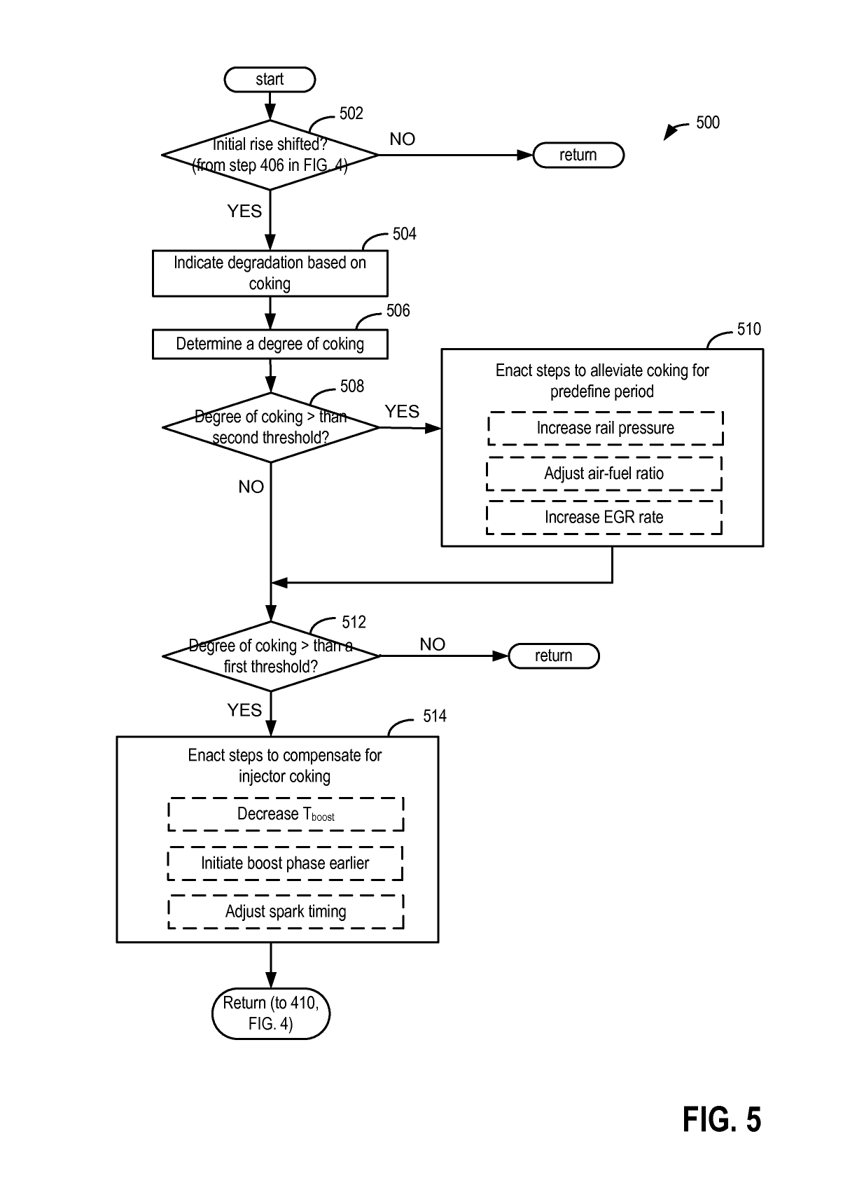

FIG. 1 describes an example engine system utilizing a fuel injector that may be subject to coking FIG. 2 describes various driver circuits that may be used to operate the injector, and further which may be used to identify coking. An example current profile with and without coking is provided in FIG. 3. FIGS. 4-5 describe routines that may be carried out by the control system of FIG. 1 to identify, and address, injector coking.

FIG. 1 depicts an example embodiment of a combustion chamber or cylinder of internal combustion engine 10. Engine 10 may receive control parameters from a control system including controller 12 and input from a vehicle operator 130 via an input device 132. In this example, input device 132 includes an accelerator pedal and a pedal position sensor 134 for generating a proportional pedal position signal PP. Cylinder (herein also “combustion chamber’) 14 of engine 10 may include combustion chamber walls 136 with piston 138 positioned therein. Piston 138 may be coupled to crankshaft 140 so that reciprocating motion of the piston is translated into rotational motion of the crankshaft. Crankshaft 140 may be coupled to at least one drive wheel of the passenger vehicle via a transmission system. Further, a starter motor may be coupled to crankshaft 140 via a flywheel to enable a starting operation of engine 10. Cylinder 14 can receive intake air via a series of intake air passages 142, 144, and 146. Intake air passage 146 may communicate with other cylinders of engine 10 in addition to cylinder 14. In some embodiments, one or more of the intake passages may include a boosting device such as a turbocharger or a supercharger. For example, FIG. 1 shows engine 10 configured with a turbocharger including a compressor 174 arranged between intake passages 142 and 144, and an exhaust turbine 176 arranged along exhaust passage 148. Compressor 174 may be at least partially powered by exhaust turbine 176 via a shaft 180 where the boosting device is configured as a turbocharger. However, in other examples, such as where engine 10 is provided with a supercharger, exhaust turbine 176 may be optionally omitted, where compressor 174 may be powered by mechanical input from a motor or the engine. A throttle 20 including a throttle plate 164 may be provided along an intake passage of the engine for varying the flow rate and/or pressure of intake air provided to the engine cylinders. For example, throttle 20 may be disposed downstream of compressor 174 as shown in FIG. 1, or alternatively may be provided upstream of compressor 174.

Exhaust passage 148 may receive exhaust gases from other cylinders of engine 10 in addition to cylinder 14. Exhaust gas sensor 128 is shown coupled to exhaust passage 148 upstream of emission control device 178. Sensor 128 may be selected from among various suitable sensors for providing an indication of exhaust gas air/fuel ratio such as a linear oxygen sensor or UEGO (universal or wide-range exhaust gas oxygen), a two-state oxygen sensor or EGO (as depicted), a HEGO (heated EGO), a NOx, HC, or CO sensor, for example. Emission control device 178 may be a three way catalyst (TWC), NOx trap, various other emission control devices, or combinations thereof.

Exhaust temperature may be measured by one or more temperature sensors (not shown) located in exhaust passage 148. Alternatively, exhaust temperature may be inferred based on engine operating conditions such as speed, load, air-fuel ratio (AFR), spark retard, etc. Further, exhaust temperature may be computed by one or more exhaust gas sensors 128. It may be appreciated that the exhaust gas temperature may alternatively be estimated by any combination of temperature estimation methods listed herein.

Each cylinder of engine 10 may include one or more intake valves and one or more exhaust valves. For example, cylinder 14 is shown including at least one intake poppet valve 150 and at least one exhaust poppet valve 156 located at an upper region of cylinder 14. In some embodiments, each cylinder of engine 10, including cylinder 14, may include at least two intake poppet valves and at least two exhaust poppet valves located at an upper region of the cylinder.

Intake valve 150 may be controlled by controller 12 by cam actuation via cam actuation system 151. Similarly, exhaust valve 156 may be controlled by controller 12 via cam actuation system 153. Cam actuation systems 151 and 153 may each include one or more cams and may utilize one or more of cam profile switching (CPS), variable cam timing (VCT), variable valve timing (VVT) and/or variable valve lift (VVL) systems that may be operated by controller 12 to vary valve operation. The operation of intake valve 150 and exhaust valve 156 may be determined by valve position sensors (not shown) and/or camshaft position sensors 155 and 157, respectively. In alternative embodiments, the intake and/or exhaust valve may be controlled by electric valve actuation. For example, cylinder 14 may alternatively include an intake valve controlled via electric valve actuation and an exhaust valve controlled via cam actuation including CPS and/or VCT systems. In still other embodiments, the intake and exhaust valves may be controlled by a common valve actuator or actuation system, or a variable valve timing actuator or actuation system. A cam timing may be adjusted (by advancing or retarding the VCT system) to adjust an engine dilution in coordination with an EGR flow thereby reducing EGR transients and improving engine performance.

Cylinder 14 can have a compression ratio, which is the ratio of volumes when piston 138 is at bottom center to top center. Conventionally, the compression ratio is in the range of 9:1 to 10:1. However, in some examples where different fuels are used, the compression ratio may be increased. This may happen, for example, when higher octane fuels or fuels with higher latent enthalpy of vaporization are used. The compression ratio may also be increased if direct injection is used due to its effect on engine knock.

In some embodiments, each cylinder of engine 10 may include a spark plug 192 for initiating combustion. Ignition system 190 can provide an ignition spark to combustion chamber 14 via spark plug 192 in response to spark advance signal SA from controller 12, under select operating modes.

As a non-limiting example, cylinder 14 is shown including one fuel injector 166. Fuel injector 166 is shown coupled directly to cylinder 14 for injecting fuel directly therein in proportion to the pulse width of signal FPW received from controller 12 via electronic driver 168. Example drivers for the boost, pickup and hold phases of electronic driver 168 are described herein below in reference to FIGS. 2A-C. In this manner, fuel injector 166 provides what is known as direct injection (hereafter also referred to as “DI”) of fuel into combustion cylinder 14. While FIG. 1 shows injector 166 as a side injector, it may also be located overhead of the piston, such as near the position of spark plug 192. Fuel may be delivered to fuel injector 166 from a high pressure fuel system 8 including fuel tanks, fuel pumps, and a fuel rail. Alternatively, fuel may be delivered by a single stage fuel pump at lower pressure, in which case the timing of the direct fuel injection may be more limited during the compression stroke than if a high pressure fuel system is used. Further, while not shown, the fuel tanks may have a pressure transducer providing a signal to controller 12. It will be appreciated that, in an alternate embodiment, injector 166 may be a port injector providing fuel into the intake port upstream of cylinder 14.

As described above, FIG. 1 shows only one cylinder of a multi-cylinder engine. As such each cylinder may similarly include its own set of intake/exhaust valves, fuel injector(s), spark plug, etc.

While not shown, it will be appreciated that engine 10 may further include one or more exhaust gas recirculation passages for diverting at least a portion of exhaust gas from the engine exhaust to the engine intake. As such, by recirculating some exhaust gas, an engine dilution may be affected which may improve engine performance by reducing engine knock, peak cylinder combustion temperatures and pressures, throttling losses, and NOx emissions. The one or more EGR passages may include an LP-EGR passage coupled between the engine intake upstream of the turbocharger compressor and the engine exhaust downstream of the turbine, and configured to provide low pressure (LP) EGR. The one or more EGR passages may further include an HP-EGR passage coupled between the engine intake downstream of the compressor and the engine exhaust upstream of the turbine, and configured to provide high pressure (HP) EGR. In one example, an HP-EGR flow may be provided under conditions such as the absence of boost provided by the turbocharger, while an LP-EGR flow may be provided during conditions such as in the presence of turbocharger boost and/or when an exhaust gas temperature is above a threshold. The LP-EGR flow through the LP-EGR passage may be adjusted via an LP-EGR valve while the HP-EGR flow through the HP-EGR passage may be adjusted via an HP-EGR valve (not shown).

Controller 12 is shown in FIG. 1 as a microcomputer, including microprocessor unit 106, input/output ports 108, an electronic storage medium for executable programs and calibration values shown as read only memory chip 110 in this particular example, random access memory 112, keep alive memory 114, and a data bus. Controller 12 may receive various signals from sensors coupled to engine 10, in addition to those signals previously discussed, including measurement of inducted mass air flow (MAF) from mass air flow sensor 122; engine coolant temperature (ECT) from temperature sensor 116 coupled to cooling sleeve 118; a profile ignition pickup signal (PIP) from Hall effect sensor 120 (or other type) coupled to crankshaft 140; throttle position (TP) from a throttle position sensor; and manifold absolute pressure signal (MAP) from sensor 124. Engine speed signal, RPM, may be generated by controller 12 from signal PIP. Manifold pressure signal MAP from a manifold pressure sensor may be used to provide an indication of vacuum, or pressure, in the intake manifold. Still other sensors may include fuel level sensors and fuel composition sensors coupled to the fuel tank(s) of the fuel system.

Storage medium read-only memory 110 can be programmed with computer readable data representing instructions executable by processor 106 for performing the methods described below as well as other variants that are anticipated but not specifically listed.

Turning now to FIGS. 2A-C, example input drivers for the injector 166 (shown in FIG. 1) are depicted. The injector driver has multiple phases to control the injector 166 shown in FIG. 1 that control the firing of injector 166. Each of the drivers may be components of engine controller 12.

In FIG. 2A a schematic depiction of the injector driver is shown that controls current during the boost phase of fuel injection. The injector driver of this initial boost phase includes inputs I_{boost} and T_{max boost}. I_{boost} is a calibrated target peak current during boost. I_{boost} may vary dependent on injector size. T_{max boost} is a calibrated maximal time to achieve I_{boost}. These input values may also be affected by injector coking as coking may influence a size and shape of an injector opening and also the speed with which the injector opens, or force needed to open the injector. The injector driver of FIG. 2A takes the target inputs and outputs U_{boost} and T_{boost}, U_{boost} being the open capacitor voltage during the boost phase, and T_{boost} being the time to achieve I_{boost}.

Referring now to FIG. 2B, a schematic depiction of the injector driver for the pickup phase of fuel injection is shown. The injector driver for the pickup phase receives inputs I_{Aeff}, T₁, and T₂. I_{Aeff} is the calibrated effective current during pickup phase. T₁ is the calibrated duration of the pickup phase together with the boost phase. T₂ is the calibrated transition time between pickup current and holding current. The injector driver for the hold phase then outputs U_{pickup} and I_{A}.

Turning now to FIG. 2C, a schematic depiction of the injector driver for the hold phase of fuel injection is shown. The hold phase is the phase in which the injector is maintained open while supplying fuel into the combustion chamber. Inputs to the injector driver for the hold phase include I_{Holdeff}, I_{HysMax}, and Tᵢ. I_{Holdeff} is the calibrated effective current during the pickup phase. I_{Holdeff} may indicate a difference in injector behavior from a base line that may be due to coking I_{Hysmax} is the calibrated maximal hysteresis at current control during hold phase. Tᵢ is the requested pulse width. The injector driver for the hold phase outputs U_{Hold} and I_{Hold}. U_{Hold} is the voltage during the hold phase and I_{Hold} is the current during the hold phase.

FIG. 3 shows an example averaged current trace from an injector with coking (dashed line) and a clean injector (solid line). The average trace of the coked injector shows a right shift indicating an increase in time to reach a target peak current. This may be due to mechanical or electrical resistance caused by injector coking and may be alleviated by corresponding adjustments to injector drivers or by enacting steps to remove coking on the fuel injectors described in greater detail below in reference to FIG. 5. The boost phase is the steep initial increase in current indicated by 302, which peaks at 303, the pickup phase is the decrease and leveling off of current indicated by 304, and a portion of the hold phase is seen as the current levels off at 306.

In FIG. 4, a flow chart of a method in accordance with the present disclosure is shown. The method 400 starts at 402 where an injector current profile is determined. Values determined by injector drivers for the boost, pickup, and hold phase of fuel injection may be used by engine controller 12 to determine the current profile of the injector opening.

Next at 404, the injector current profile is compared to a base profile. The base profile may be a learned profile, taken periodically, for example following an injector cleaning cycle following replacement of the injectors. Furthermore, the base profile may be a stored profile that has been uploaded to read-only-memory 110 of engine controller 12 for example. The base profile may comprise an entire profile such as that shown in FIG. 3, or may comprise a time to peak current, starting with the onset of the boost phase 302 until the peak current at 303.

At 406, it is determined from the comparison of 404 if the initial rise or boost phase 302 is shifted compared to the base profile. This shift may be determined in reference to an average trace or a current profile for an individual injection. The shift may further be determined based on a predetermined threshold for a time lag at a given current. In an alternative example, the shift may be determined based on a threshold for probability of statistical difference between the two traces. If the initial boost phase of the injector current profile is not shifted (NO) the method then returns. If at 406, the initial slope of the injector boost phase is shifted (YES), the method proceeds to step 407 where it is indicated that there is degradation of an injector based on coking, and further that a diagnostic code that an injector is coked is set. Furthermore, an air-fuel ratio measurement may be used to determine if the fuel metering of the injector is a different from a desired tolerance.

Once injector coking is indicated at 407, steps are taken to alleviate or compensate for injector coking at 408. These steps may include adjusting fuel scheduling or other operating parameters. This may include: revising the feed forward fuel metering (e.g. injector open delay and/or static fuel flow assumption); adjusting the injection timing to compensate for shift in opening time; adjusting the fuel rail pressure to compensate for fuel spray changes; adjusting other engine operating parameters (e.g. spark timing, speed/load) to help remove injector coking. These steps are described in greater detail below in reference to FIG. 5. It should be understood that these steps are enacted by engine controller 12, taking into consideration operating parameters of the engine. Some steps may not be undertaken during all engine conditions. In addition to steps undertaken to alleviate the coking of the injector, the current supplied to the fuel injector may be altered to compensate for the coking. For example, the input T_{boost} (the time to achieve I_{boost}) to the injector driver for the boost phase (shown in FIG. 2A) may be decreased. In addition, or alternative to, decreasing T_{boost} increasing I_{boost} may also be used in compensating for injector degradation.

Once methods to compensate for, or alleviate injector coking are enacted at step 410 it is again assessed if the initial slope and therefore the time to peak current, or boost phase 302, of the injector current profile is shifted. If the answer at step 410 is NO, steps enacted at 408 may have been successful and indication of injector degradation based on coking is removed at step 411. If, at 410, the boost phase of the injector current profile is still shifted (YES) injector coking may persist and alterations to the current drivers may not be sufficient to compensate for the coking.

The method then proceeds to 412 where a signal may be generated to replace the injector. Once the injector is replaced the indication of degradation based on coking is removed at step 414. In the event an injector is replaced a new base profile of the injector current profile may be acquired and stored within the engine controller for future comparisons. The method then returns.

It should be understood that variations to the method are possible. For example, an indication of degradation at step 410 may result in different or additional steps to alleviate injector coking and injectors may be replaced on a timed or distance travelled dependent basis instead of, or in addition to, upon persistent coking.

Turning now to FIG. 5 a method is shown to alleviate or compensate for injector coking. The method 500 starts at 502 where it is determined if the initial rise of the injector current profile is shifted as in step 406 in FIG. 4. If the injector current profile is not shifted (NO), the method then returns.

If at 502, the injector current profile is shifted compared to a base profile (YES) the method proceeds to step 504 where it is indicated that there is degradation of an injector based on coking, and further that a diagnostic code that an injector is coked is set. At 506, a degree of coking is determined. The degree of coking may be determined by the amount of offset of a peak current (see 303 in FIG. 3) between an injector current profile and a base profile. This offset may be measured as a difference between a time to peak current and the base current profile which may be a basal time to peak current In alternative embodiment the degree of coking may be determined as a difference in a slope of the boost phase (see 302 in FIG. 3) between an injector current profile and a base profile.

AT 508, it is determined if the degree of coking is greater than a first threshold. A second threshold may be a time difference in a peak of the boost phase (see 303 in FIG. 3) between a base profile and an injector current profile. Furthermore, a second threshold may be a slope difference of the boost phase (see 302 in FIG. 3). If, at 508, the degree of coking exceeds a second threshold (YES) the method proceeds to step 510 where steps to alleviate the injector coking are enacted.

Among possible actions to remove coking from an injector include increasing the fuel rail pressure, adjusting the air-fuel ratio, or increasing an EGR rate. Increasing the rail pressure may provide a mechanical force to remove coking on an injector tip or may increase an amount of fuel injected through a coked injector opening. Alterations to an air-fuel ratio or an EGR rate may result in the availability of unburned hydrocarbons that can act as reducing agents for coking residues. Furthermore, adjustments to the air-fuel ratio and EGR rate may alter a combustion temperature which may further increase the likelihood of reducing coking residues. Various methods for alleviating coking may be carried out for a predefined amount of time, or number of engine cycles. Furthermore, an additional check of the injector current profile compared to a base profile may be carried out to determine if injector coking has been sufficiently alleviated.

If, at 508, injector coking does not exceed a second threshold (NO) the method proceeds to step 512 where it is assessed if the injector coking exceeds a first threshold. The first threshold may be based on the same parameters of the second threshold. However, the first threshold may comprise a lesser time offset in the peak of the boost phase 303, or a lesser extent in a slope difference of the boost phase 302. If this first threshold is not exceeded (NO) a degree of coking is not sufficient to appreciably affect fuel injection and the method returns.

If, at 512, the first threshold is exceeded (YES) steps are enacted to compensate for injector coking at 514. Among these steps are adjusting injector actuation, a specific example of which may be altering the boost phase injector driver (shown in FIG. 2A) by increasing I_{boost} and or decreasing T_{boost}. T_{boost} may be decreased in a way to increase the slope of the boost phase or such that the boost phase is initiated at an earlier time point, or both. Increasing I_{boost} (the target peak current during boost) or decreasing T_{boost} (the time to achieve I_{boost}) may result in an injector current profile which is not shifted and more closely resembles the base profile and has the effect of adjusting the injection timing. A larger capacitor may be provided in an injector circuit in accordance with the present disclosure to provide an increased boost voltage used in compensating for injector coking. A net effect of adjusting injector driving signal may be that a fuel injection opening duration is increased for a given requested fuel injection amount. Adjustments to spark timing may also be used to compensate for altered injecting timing due to a coked injector. For example a degree of spark retard may be increased or reduced based on a degree of estimated injector coking. The spark adjustment may be on a per cylinder basis, tied to the cylinder for which injector coking is identified. In this way, spark timing may be adjusted differently among different cylinders of the engine (e.g., a first and second cylinder) based on the different degrees of coking among those different (first and second) engine cylinders. Further, the spark adjustment may be confined only to selected conditions, such as during starting, or during non-starting conditions. Once steps are enacted to compensate for injector coking, the method then returns to step 410 of FIG. 4.

It should be understood, that actions to both alleviate coking, and to compensate for coking may be undertaken simultaneously, in an alternative embodiment. Furthermore, actions to compensate for coking may be more successful under conditions of high engine demand where alterations to air-fuel ratio or EGR rate, for example may be less practical.

The present disclosure describes a system and method for compensating for, or alleviating accumulation of coking residues on fuel injectors. The method comprises adjusting an engine operating parameter based on a shift in a fuel injector current profile during an initial current rise of injector activation.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
adjusting an engine operating parameter based on a shift in a fuel injector current profile during an initial current rise of injector activation.

2. The method of claim 1, wherein a shift in a fuel injector current profile is a change in a time to peak current.

3. The method of claim 1, further comprising indicating degradation of the fuel injector when the shift is greater than a threshold shift.

4. The method of claim 1, wherein the shift is based on a difference between the fuel injector current profile and a base profile.

5. The method of claim 4, wherein the shift is a change in the time to peak current from a base profile, wherein the base profile is a basal time to peak current.

6. The method of claim 4, wherein the base profile is a learned injector profile.

7. The method of claim 4, wherein the base profile is a stored injector profile.

8. The method of claim 1, wherein adjusting the engine operating parameter comprises increasing a fuel injection opening duration for a given requested fuel injection amount.

9. The method of claim 1, wherein adjusting the engine operating parameter comprises increasing fuel rail pressure.

10. The method of claim 1, wherein adjusting the engine operating parameter comprises adjusting injector actuation.

11. The method of claim 10, wherein adjusting injector actuation comprises increasing a time to achieve a target peak current during a boost phase of fuel injector actuation.

12. A system for an engine comprising:
an injector controlled by an injector timing signal, the injector timing signal delivered by an injector driver comprising: a boost phase, a pickup phase, and a hold phase; and
an engine controller including instructions stored in memory to adjust operation based on whether a boost phase of an injector current profile is different from the boost phase of a base profile.

13. The system of claim 12, wherein the boost phase comprises an initial increase in current delivered to the fuel injector.

14. The system of claim 12, wherein determining if the boost phase of an injector current profile is different from the base profile further comprises determining if a time lag of the injector current profile at a predetermined current compared to the base profile is greater than a predetermined threshold.

15. The system of claim 12, further comprising an air-fuel ratio measurement that determines if the fuel metering of the injector is different from a desired tolerance.

16. The system of claim 12, further comprising a fuel rail wherein a fuel rail pressure is increased if it is determined that the boost phase of an injector current profile is different from the boost phase of a base profile.

17. The system of claim 12, wherein the injector driver comprises input for a target peak current, time to achieve target peak current and a maximal time to achieve the target peak current.

18. A method, comprising:
controlling fuel injection with an injector driver;
comparing an injector current profile to a base profile;
determining if a boost phase of the injector current profile differs from the base profile; and
enacting steps to alleviate injector coking if it is determined the boost phase of the injector current profile is different from the base profile.

19. The method of claim 18, wherein the injector current profile is a time to peak current and the base current profile is a basal time to peak current.

20. The method of claim 18, wherein the injector driver further comprises a boost phase, a pickup phase, and a hold phase.
